(19) United States
(12) Patent Application Publication
(10) Pub. No.: US 2016/0321764 A1
(43) Pub. Date: Nov. 3, 2016

(54) METHOD OF AND SYSTEM FOR PLANNING AND REDISTRIBUTING CONGESTED FLOWS BASED ON INTEGRATED CALENDAR INFORMATION

(71) Applicant: Flux Group, LLC, Sao Paulo (BR)

(72) Inventor: Camila Fairbanks Ribeiro Cardoso, Sao Paulo (BR)

(21) Appl. No.: 15/099,181

(22) Filed: Apr. 14, 2016

Related U.S. Application Data
(60) Provisional application No. 62/154,212, filed on Apr. 29, 2015.

(51) Int. Cl. G06Q 50/14; G06Q 10/02; G01C 21/34

(52) U.S. Cl. CPC G06Q 50/14; G01C 21/343; G06Q 10/025

(57) ABSTRACT

Disclosed herein are methods of and systems for facilitating planning and redistributing flows. The planning and redistribution of flows may be based on, for example, but not limited to, calendar information or information inputted by users. Accordingly, embodiments may provide a platform for individual users and/or organizations to plan their respective trips and/or events/places to attend in a manner that may minimize congestion of a flow of people and/or vehicles.

### RELATED APPLICATION

Under the provisions of 35 U.S.C. §119(e), this application claims priority from provisional patent application No. 62/154,212, filed on Apr. 29, 2015 which is incorporated herein by reference in its entirety.

It is intended that each of the referenced applications may be applicable to the concepts and embodiments disclosed herein, even if such concepts and embodiments are disclosed in the referenced applications with different limitations and configurations and described using different examples and terminology.

### FIELD OF THE INVENTION

Generally, the present disclosure relates to planning, making and/or changing travel decisions by knowing what to expect of flow congestions. More specifically, the disclosure relates to forecasting flow congestion based on calendar information from a plurality of users setting the stage for flows to be more evenly distributed.

### BACKGROUND

Flow may be understood as congestion resulting from the human propagation from one location to another, using any transportation medium, including, but not limited to, for example foot, bicycle, automobile, bus, train, plane, boat, and the like. Individuals often need flow congestion estimation in order to plan a trip. They might even decide whether or not to go and when to leave if they have an accurate forecast. This goes beyond actual tools that predict when they may reach a certain destination or place, as well as when to find an alternate route or reschedule plans. For example, in terms of traffic flows, Google-Maps/Waze provides real-time estimation of traffic flow as well as an estimated arrival time. However, these estimations are made using only past statistical flow congestion, real-time traffic data and conditions data (e.g. flow congestion and weather).

As a result, individuals may not be presented with accurate or sufficient information to make specific trip plans as it is not possible to determine how to properly schedule their departure time or day, if any. Moreover, conventional systems and methods do not assess looking-forward data (e.g., future data) regarding flow congestion including but not limited to traffic flow. Consequently, conventional systems and methods do not provide people with enough information to determine if and when to go to a specific crowded place such as, for example, but not limited to, a common seasonal destination, a Museum, a Theme Park or a Ski Resort.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Disclosed herein are methods of and systems for facilitating planning and redistributing flows. The planning and redistribution of flows may be based on, for example, but not limited to, calendar information. Accordingly, embodiments may provide a platform for individual users and/or organizations to plan their respective trips and/or events in a manner that may minimize congestion of a flow of people and/or vehicles.

Initially, the platform may receive an intention of a future travel from a user in the form of a travel plan. The travel plan may comprise, but not be limited to, for example, indication of one or more of a destination location, an event, a departure time, an arrival time and a travel duration.

Subsequently, the platform may identify scheduling information from a collaborative calendar based on the travel plan. For instance, based on the date and/or time of an intended departure indicated in the travel plan, a corresponding portion of the collaborative calendar may be identified and retrieved.

The collaborative calendar may be associated with a number of users through a number of different calendar platforms or manually input information. In turn, the collaborative calendar may be accessed by the platform to indicate a user's travel related schedules and/or view travel related schedules. Accordingly, the collaborative calendar may provide access to travel related schedules of a large number of users corresponding to geographical area, highway and the like. For instance, users may be able to view travel related schedules corresponding to a region of a city.

By analyzing scheduling information from the collaborative calendar the described techniques may be able to predict flows. The flows may include flow of, for example, vehicles and people.

For instance, analysis of scheduling information in the collaborative calendar may indicate, for example, that a large number of users are planning to attend a sporting event at a stadium, or attending a Ski Resort, or taking the same route or highway. Since, the routes through which vehicles and/or people may arrive at the stadium may be determined from a map, an average flow of traffic through the routes may be computed. Further, in case the scheduling information in the collaborative calendar includes information such as one or more of departure time/day, departing location, route etc., a more accurate flow of traffic may be calculated for one or more routes connecting to the stadium. Also, in terms of people flow, it becomes possible to compare how crowded the arena can be (e.g., wait times, etc) and with that information, individuals can choose when/if to attend the event.

Additionally, based on the calculation of predicted traffic flow, congestion in one or more regions such as, but not limited to, a venue and a path, may be detected. Thus, a collaborative calendar may not be the only way to determine flow. For example, data associated with events and venues (e.g., tickets sold) may be retrieved in order to assist in the calculation of traffic and people flow.

Furthermore, based on the calculation of predicted traffic flow, travel times using various modes of transportation along one or more routes may be calculated. Similarly, waiting times at a venue, for obtaining tickets and/or entering may also be calculated, and the like.

The calculated travel times and/or the waiting times may be displayed to one or more relevant users. For example, a user whose intended travel plan includes traveling through a route that at least partially overlaps with the one or more routes may be presented with the calculated travel times based on the predicted traffic flow. For instance, the user may be presented with travel times through the route for various times of a day and various days of a week/month/season (etc.).

Accordingly, users may be enabled to plan their travel an improved way. For example, based on the travel times displayed, a user may choose a different departure time and/or departure day in order to minimize travel time. As the platform in the future may be further configured to calculate flow using a plurality of different transportation mediums (e.g., car, bus, train, plane, and boat), a user may be provided with flow associated with each transportation medium. In this way, the user may be able to plan a trip using the transportation mediums with, for example, the least flow congestion.

Consistent with embodiments of the present disclosure, a user may even decide to change the destination location and/or an event originally intended based on the travel times and/or waiting times displayed to the user. Accordingly, in some instances, based on the travel times and/or waiting times, the users may alter their intended travel plans leading to a redistribution of traffic flows.

Further still, the platform may provide users with recommendations for an altered travel plan such as an alternative departure day and/or time, an alternative destination location and/or an alternative event in order to result in a redistribution of traffic flows. Accordingly, acceptance of one or more recommended alternatives may result in an optimized flow of traffic that may minimize travel times altogether and/or in some cases eliminate congestion.

Further, in some embodiments, the collaborative calendar may also be configured to reflect scheduling information based on intentions of future travel plans indicated by users. For example, as users enter an intended travel plan into a mobile app for managing their travel, the collaborative calendar may be updated in real-time (or a minimum amount of minutes necessary to properly calculate results). Similarly, when users alter their travel plans based on travel times and/or waiting times displayed to the users, scheduling information corresponding to the altered travel plan may reflect in the collaborative calendar in real-time (or a minimum amount of minutes necessary to properly calculate results). Subsequently, further calculations of predicted traffic flows may use the updated scheduling information in the collaborative calendar leading to more reliable predictions.

Still consistent with embodiments of the present disclosure, a platform may be provided to create a planning tool that better anticipates, optimizes and distributes flows by gathering and analyzing future information provided by users. The planning tool may provide a reliable flow congestion flow forecast by utilizing, for example, a collaborative calendar with user input to more accurately predict future flow congestion and influence how flows may be distributed. Therefore, people, business owners, road concessionaries, cities, families (etc.) may be enabled to plan better.

For example, in some embodiments, a user may add an appointment to the collaborative calendar platform, with a location and time/day. Based on a user's current location and future appointment time and location, the platform may be configured to predict when and where the user might be travelling and contributing to congestion. To even further refine the accuracy of the predication, the platform may take into account each of the registered schedules (including, for example, but not limited to, time, day and location) associated with a plurality of users who have registered their schedule on the collaborative calendar. In this way, better flow congestion predictions may lead to fewer accidents, better flow congestion flow, and lower fuel use (not to mention better planning from cities', families' among others' point of view). The planning tool may help users make a well-informed decision related to traveling. Some examples of uses of the planning tool may include, but are not limited to: families can plan their days and trips better, Business owners can avoid bottlenecks (e.g. hiring an extra burger flipper in advance), Theme Parks/Ski Resorts can hire extra staff ahead of time, Government Agencies can better prepare security measures, Tour Agencies may optimize their tour schedules, etc.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 is an illustration of a platform consistent with various embodiments of the present disclosure;

FIG. 2 is a flow chart of a method for providing a planning tool comprising flow congestion predictor with calendar feedback platform in accordance with various embodiments;

FIG. 3 illustrates a screenshot for presenting a user with a selection of trip planning mode consistent with various embodiments of the present disclosure;

FIG. 4 illustrates an example screenshot of a trip-planning input interface consistent with various embodiments of the present disclosure, presented if the user clicks on button 315, where the user is presented with different destinations based on a time/date and duration of a trip;

FIG. 5 illustrates a screenshot showing potential destinations within the maximum estimated travel duration for a given departure time consistent with various embodiments of the present disclosure;

FIG. 6 illustrates a screenshot displaying potential destinations within the maximum estimated travel duration for a given departure date consistent with various embodiments of the present disclosure;

FIG. 7 illustrates a screenshot for inputting trip information for determining an ideal time to travel based on different departure time/dates consistent with various embodiments of the present disclosure, if the user clicks on button 310;

FIG. 8 illustrates a screenshot for displaying estimated travel durations based on time of departure for a given consistent date in accordance with embodiments of the present disclosure;

FIG. 9 illustrates a screenshot for displaying estimated travel durations based on date of departure for a given consistent time in accordance with various embodiments of the present disclosure;

FIG. 10 illustrates a screenshot for displaying details of a planned trip consistent with various embodiments of the present disclosure;

FIG. 11 illustrates a screenshot showing a route selection for a user in accordance with various embodiments of the present disclosure;

FIG. 12 illustrates a screenshot displaying real-time navigation in accordance with various embodiments of the present disclosure;

FIG. 13 to FIG. 16 illustrate a plurality of wireframes that, in some embodiments, may be provided to platform users;

FIG. 17 is a flow chart of a method of receiving a user's final travel plan to process a forecasted flow congestion data in accordance with various embodiments;

FIG. 18 to FIG. 25 illustrate a plurality of wireframes that, in some embodiments, may be provided to platform users expanding and illustrating how the present disclosure applies to different types of flow congestion (e.g. “people flow”) and how another vector (“budget”) shall appear for users to decide on plans according to costs; and

FIG. 26 is a block diagram of a system including a computing device/server for performing the methods of FIG. 2 and FIG. 17.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. As should be understood, any embodiment may incorporate only one or a plurality of the above-disclosed aspects of the display and may further incorporate only one or a plurality of the above-disclosed features. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of flow congestion flow, embodiments of the present disclosure are not limited to use only in this context. For example, although embodiments of the present disclosure are described with reference to automotive vehicle congestion based on calendar data, it should be understood that the various embodiments may be expanded to accommodate human congestion at various locations and venues, and be based on other elements outside of calendar data (e.g., event data, venue data, and common carrier data).

I. Platform Overview

Consistent with embodiments of the present disclosure, a flow congestion prediction with calendar feedback platform may be provided. This overview is provided to introduce a selection of concepts in a simplified form that are further described below. This overview is not intended to identify key features or essential features of the claimed subject matter. Nor is this overview intended to be used to limit the claimed subject matter's scope.

The flow congestion predictor with calendar feedback platform may be used by individuals or companies to enhance accuracy of flow congestion prediction and, above that, to make decisions of and change plans based on flow congestion. Although some embodiments of the present disclosure are described with reference to automotive vehicle congestion, it should be understood that the various embodiments may be expanded to accommodate human congestion at various locations and venues.

The platform may be embodied as, at least in part, a software application. The configuration of the software application and associated servers will be provided below. The software application may enable users to plan around flow congestion by providing, to the users, a plurality of proposed trip times (and, in some embodiments, proposed trip dates) based on an input of a desired time and destination received from the users. The proposed trip times and dates may be based on, but not limited to, for example, flow congestion data (e.g., current, historical, and future) as well as the schedules registered on a plurality of users' calendars. Such calendars may include a destination and a time that an individual intends to depart for an appointment or to have the appointment at (e.g., a meeting or any other scheduled event).

The platform may be configured to aggregate flow congestion and calendar data in order to calculate a proposed scheduling time and day/date. The proposed scheduling time may help a platform user to schedule a better time for the event (e.g., departure time and date), considering the flow congestion conditions associated with the user's desired time as compared with the platform's proposed options of time/day.

Consistent with embodiments of the present disclosure, the platform may present the user with a plurality of scheduling options. For example, upon flow congestion calculation, the platform may provide a list of times and days and flow congestion status associated with those times and days. In this way, the platform user may be enabled to select a scheduling time and day most suitable for the user (e.g., the user might even decide to postpone a trip for months or not go at all now with more accurate information). Furthermore, the platform may provide users with alternative destinations or events to attend (those similar to the events/destinations specified). The alternative selections may be provided based on improved flow dynamics at the alterative destinations/events.

In yet further embodiments, given the day or time for which the user would like/intend to leave, the platform may provide the user with alternative destinations (rather than alternative times/days) corresponding to the user's desired scheduling time/day and duration of the trip. These alternative destinations may be related to the initially specified possible destinations by the user, but not limited to them (e.g., the platform might be able to identify a certain profile and interests and suggest a destination). For example, if the user often goes to a specific Ski Resort in the East Coast (e.g., Killington), the platform may suggest other Ski Resorts in the area for which the user would experience a similar duration of a trip/travel congestion (e.g., 2 and a half hours of duration on the road, door to door) informed by the user given the desired time/day of departure. Additionally, in some embodiments, the application may provide the user with estimated trip costs.

Embodiments of the platform may be configured to further provide a set of alternate destinations to the user based on, for example, but not limited to, the user's distance from a desired destination or the duration of the trip in terms of minutes. In other words, if a user inputs a desired destination that is four hours (including flow congestion and travel time) away from the user's current location, the platform may calculate another destination that may also require a similar travel time for the user, as well as the associated costs.

In some embodiments, the platform may consider budgeting information. For example, the platform may present users with destination options given a pre-specified budget for departing on a certain time/day. Or, in other embodiments given the destination, the platform may present options of time/day departure for the user based on the pre-specified budget (considering, for example, costs of transportation such as, for example, but not limited to, fuel and airfare and even including a hotel).

Further still, the plurality of calculated alternative destinations and/or alternate time/day's for desired locations as a listing for selection to the user. In some embodiments, once the user selects the desired trip destination, day and time, the platform may provide the user with an ideal route or the user might select a route from a list as well as real-time navigation instructions. The real-time navigation instructions may be provided to the user through the platform at the proper time. Moreover, the selected trip may be added to the “collaborative calendar” so that the information may be used to predict further flow congestion. At or around the time of the scheduled event, the real-time navigation instructions may be provided to the user through the platform, whereas the ideal trip plan (as well as route directions) may be available to the user for review or edit at anytime.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

II. Platform Configuration

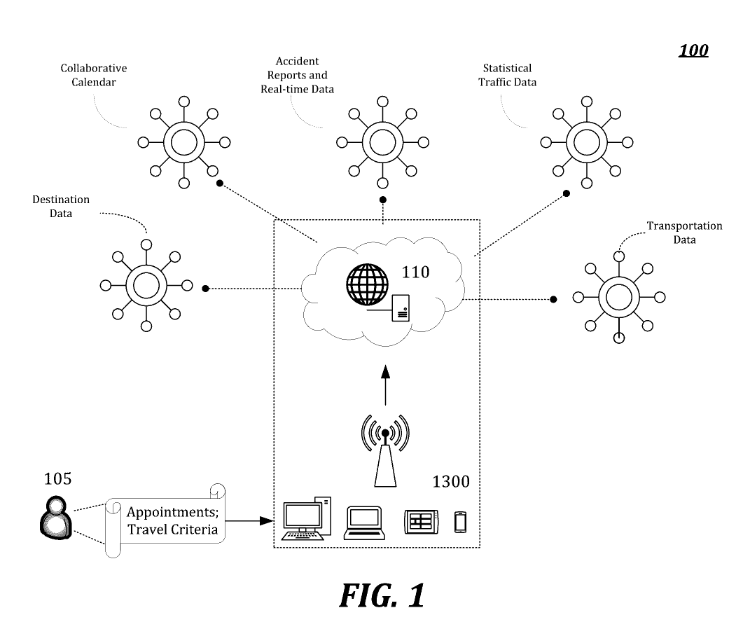

FIG. 1 is an illustration of a platform consistent with various embodiments of the present disclosure. By way of non-limiting example, a planning tool with a flow congestion predictor with calendar feedback platform 100 may be hosted on a centralized server 110, such as, for example, a cloud computing service. The centralized server may communicate with other networks that have applicable data, such as, for example, other flow congestion prediction networks. A user 105 may access platform 100 through a software application. The software application may be embodied as, for example, but not be limited to, a website, a web application, a desktop application, and a mobile application compatible with a computing device 2600. One possible embodiment of the software application may be provided by the GOFLOW™ suite of products and services.

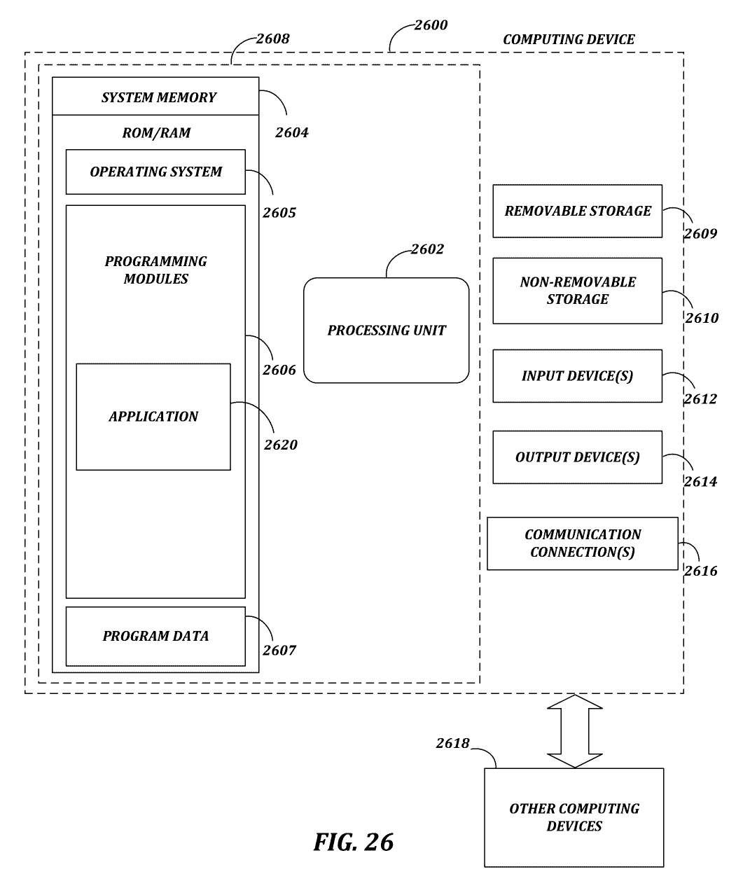

As will be detailed with reference to FIG. 26 below, the computing device through which the platform may be accessed may comprise, but not be limited to, for example, a desktop computer, laptop, a tablet, or mobile telecommunications device. As will be detailed with reference to FIG. 26 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

In some embodiments, the platform may integrate with a user's calendar (e.g., Google, Yahoo, Outlook, and the like). In yet further embodiments, the platform may further provide a stand-alone calendar that integrates with the user's other calendars. In yet further embodiments, the platform may provide a stand-alone calendar to all platform users.

The platform consistent with embodiments of the present disclosure may be configured to receive information from a plurality of databases. The databases may include, but not be limited to, for example, destination data (e.g., information about various geographical locations, venues, events, places, meetings, amount of attendees, and the like), collaborative calendar data (e.g., information about various schedules associated with the users of the platform), accident reports and real-time traffic data (e.g., congestion and traffic data or people congestion data), statistical traffic data (e.g., historical congestion data and future congestion predications), and transportation data (bus schedules, train schedules, flight schedules, taxi information, and the like) or planned human activities (tickets sold in a concert, lift tickets sold for a specific day/period/season, tickets sold in a Sports Event, and the like). The information received from these databases may be employed in providing options of departure, scheduling, destination, and flow congestion data to the various embodiments disclosed herein.

III. Platform Operation

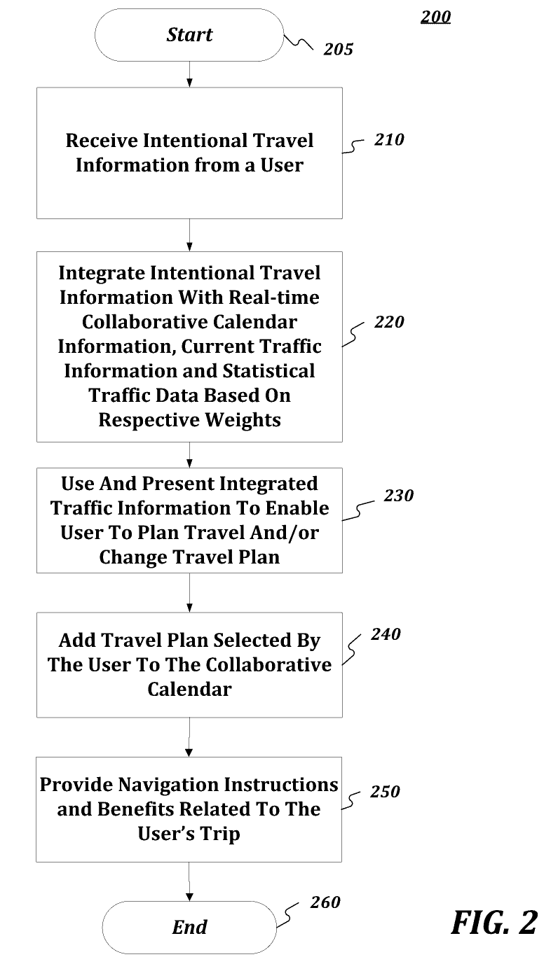

FIG. 2 is a flow chart of a method 200 for providing a planning tool comprising flow congestion predictor with calendar feedback platform 100 in accordance with various embodiments. Method 200 may be implemented using a computing device 2600 as described in more detail below with respect to FIG. 26.

Although method 200 has been described to be performed by platform 100, it should be understood that computing device 2600 may be used to perform the various stages of method 200. Furthermore, in some embodiments, different operations may be performed by different networked elements in operative communication with computing device 2600. For example, server 110 may be employed in the performance of some or all of the stages in method 200. Moreover, server 110 may be configured much like computing device 2600.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

Method 200 may begin at starting block 205 and proceed to stage 210 where platform 100 may receive intentional travel information from a user. For instance, intentional appointment information (i.e. what would first interest the user—before the user receives a first output from the platform) may be received. As an example, platform 100 may receive this information from one or more “collaborative calendars” and/or information entered by the user. For example, platform 100 may receive information from Google Calendar. Such information may include a time of an appointment and location for the appointment. The location may be, for example, an address, place or a set of GPS coordinates. Further, the platform may receive user current location information. For example, the platform may receive user GPS coordinates from the user's mobile phone. Such information may be used to predict when and where a user may be on the road and contributing to flow congestion.

From stage 210, where platform 100 receives user and appointment information, method 200 may advance to stage 220 where platform 100 may integrate the intentional travel information with real-time collaborative calendar information, current traffic information and statistical traffic data considering respective weights. For example, platform 100 may integrate historical flow congestion data. In addition, platform 100 may integrate current flow congestion data. Platform 100 may use integrated data to compute predicted congestion and estimated travel times.

Integration may include a calculation and execution of an algorithm at a centralized server location (e.g., a cloud computing server). The algorithm may continually learn user behaviour by studying, for example, up-to-date calendar activity and platform search activity. In this way, the algorithm can be continually updated and provide optimized flow predications.

Once platform 100 integrates collaborative calendar information with current flow congestion information and statistical flow congestion data in stage 220 and calculates options to the user within the algorithm, method 200 may continue to stage 230 where platform 100 may use integrated flow congestion information to enable users to plan travel, including changing the date and/or time of departure or deciding not to proceed with the plan. Accordingly, the user may be able to make a well-informed decision. Further, at step 240, based on a selection made by the user, a final travel plan may be added to the collaborative calendar and also used for calculating subsequent flow congestion prediction. For example, a user may choose to determine the best time/day to go to a location. Alternatively, a user may want to determine the best place to go at a given time given the duration provided by the platform. Platform 100 may provide the user with ways in which the application may be utilized.

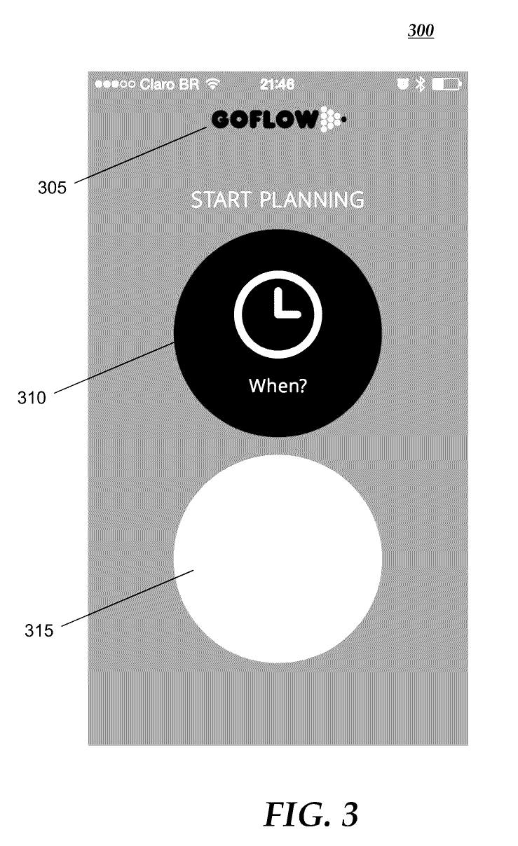

FIG. 3 illustrates a screenshot for presenting a user with a selection of trip planning mode consistent with various embodiments of the present disclosure. Title bar 305 may show the name of the application. “When button” 310 may enable a user to select the option for the platform to present the best time to go to a location. “Where button” 315 may enable a user to select the option for the platform to present the best place to go at a given time and given travel time (duration of the trip).

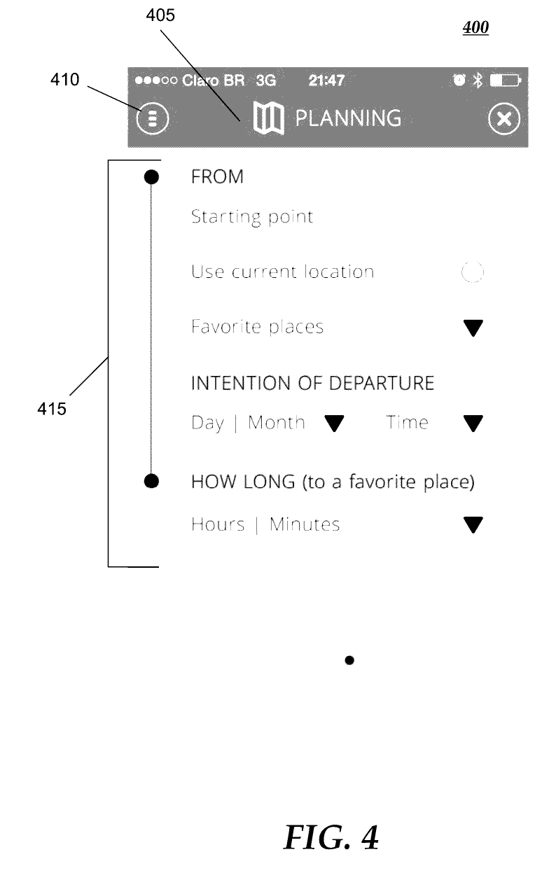

Upon selection of the “where button” 310, the platform may provide the user with an interface for inputting trip information for determining an ideal destination. FIG. 4 illustrates an example screenshot of how such interface may look consistent with embodiments of the present disclosure. Trip information inputs 415 may enable the user to input relevant information, such as, for example, a starting point, a destination, a day and time of departure, and a maximum estimated travel duration.

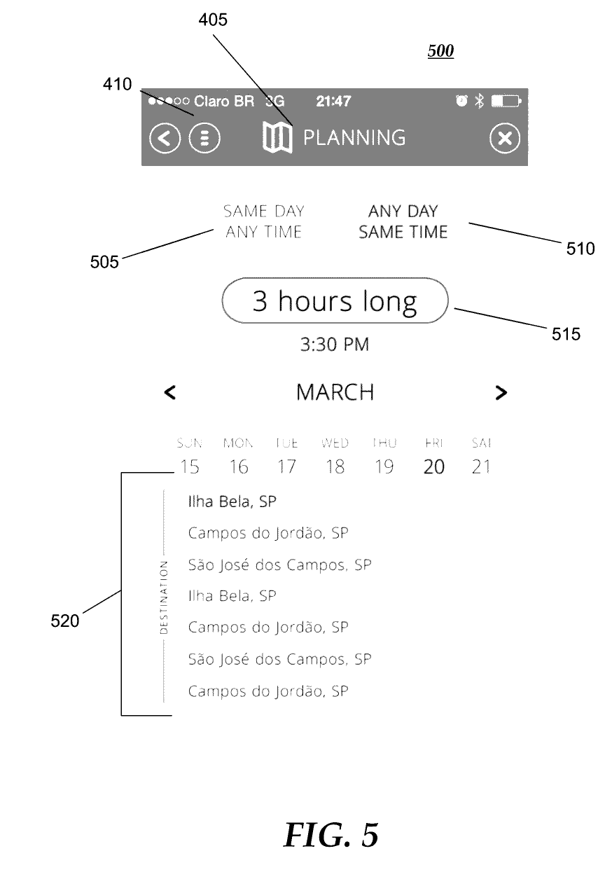

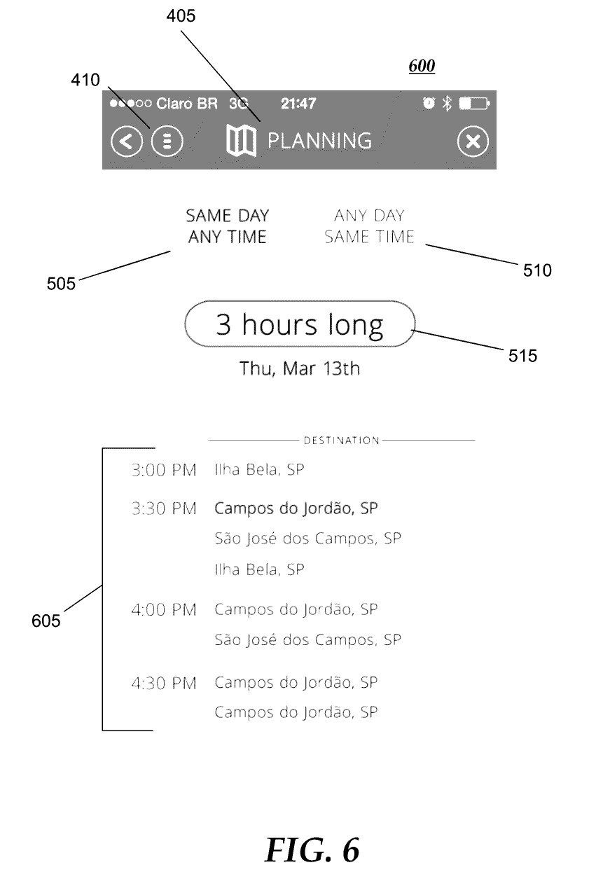

Upon input of trip information, the application may present the user with potential destinations. FIG. 5 illustrates a screenshot consistent with embodiments of the present disclosure showing potential destinations within the maximum estimated travel duration 515 for a given departure time. With a selection of “same day any time” button 505, the platform may provide the user with an opportunity to vary the time of departure, while keeping the departure date constant, to show which destinations may be within the maximum estimated travel duration. Alternatively, the user may select “any day, same time” button 510. Upon receiving selection of the “any day, same time” button 510, the platform may provide the user with an opportunity to vary the date of departure, while keeping the departure time constant to show destinations 520 within the maximum estimated travel duration. FIG. 6 illustrates a screenshot consistent with embodiments of the present disclosure displaying potential destinations within the maximum estimated travel duration for a given departure date. Potential destinations within the maximum estimated travel duration based on departure time 605 may be presented.

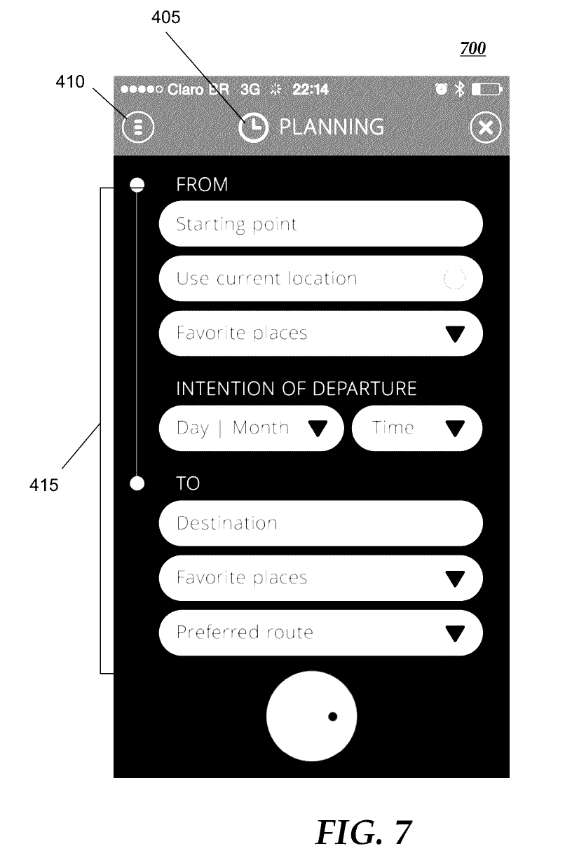

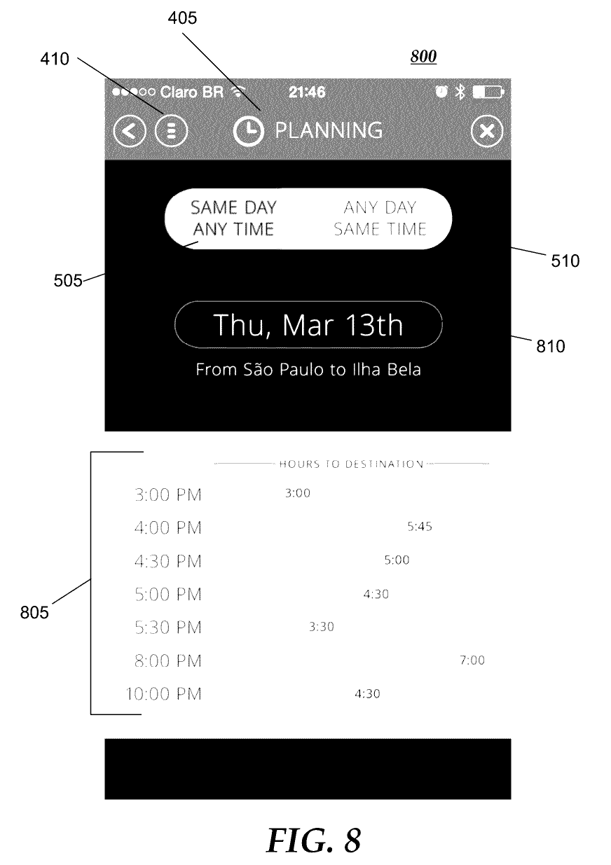

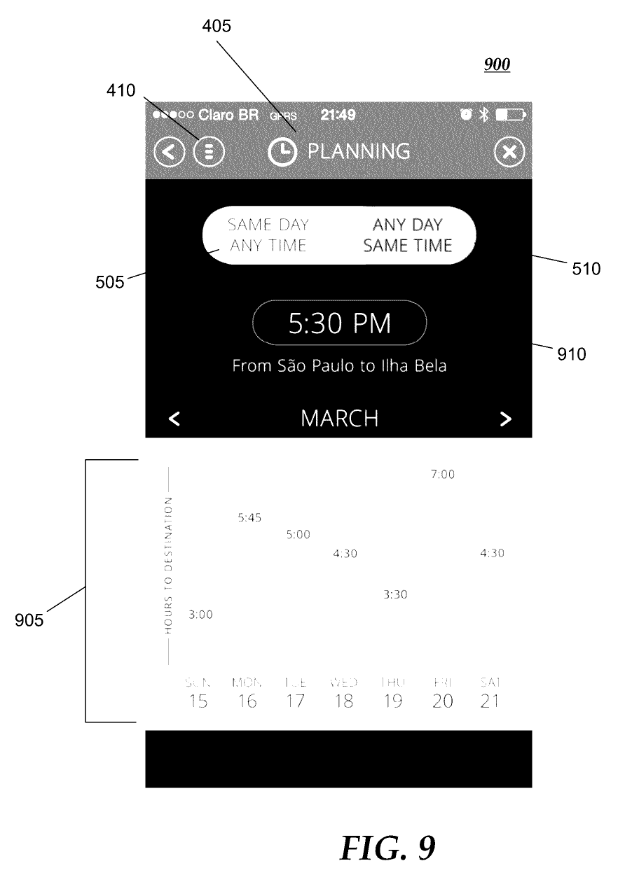

Alternatively, upon receiving a selection of the “when button” 305, the platform may provide the user with an interface for inputting trip information for determining an ideal time/day to travel. FIG. 7 illustrates a screenshot consistent with embodiments of the present disclosure for inputting trip information for analyzing an ideal time and day to travel. Upon receiving trip information inputs 415, platform 100 may display estimated travel durations based on either date of departure or time of departure. Platform 100 may present the user with an option to select between “any time, same day” button 505 and “any day, same time” button 510. FIG. 8 illustrates a screenshot consistent with embodiments of the present disclosure for displaying estimated travel durations based on time of departure on a given day 805. FIG. 9 illustrates a screenshot consistent with embodiments of the present disclosure for displaying estimated travel durations based on date of departure on a given time 905.

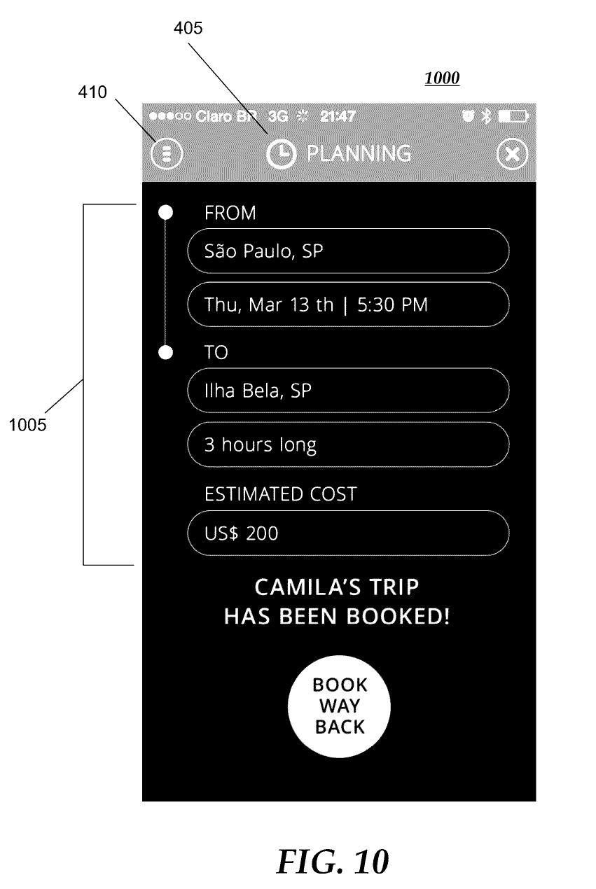

Further, in some embodiments, after platform 100 uses integrated flow congestion information to enable users to plan travel, method 200 may proceed to stage 240, where platform 100 may receive final chosen travel information and add the travel information to the collaborative calendar. For example, a user may select a specific day, time and location for travelling from one of the presented options. Upon receiving such selection, platform 100 may save a user's selection and use it for further calculations. FIG. 10 illustrates a screenshot consistent with embodiments of the present disclosure for displaying details of a planned (and saved) trip. Travel details 1005 may be displayed to the user. Platform 100 may then store such information in the collaborative calendar. The stored information may be used to predict when and where the user will likely on the road and contributing to the congestion, thus affecting flow congestion predictions to everyone and possibly affecting other people's plan, thus distributing flows more evenly.

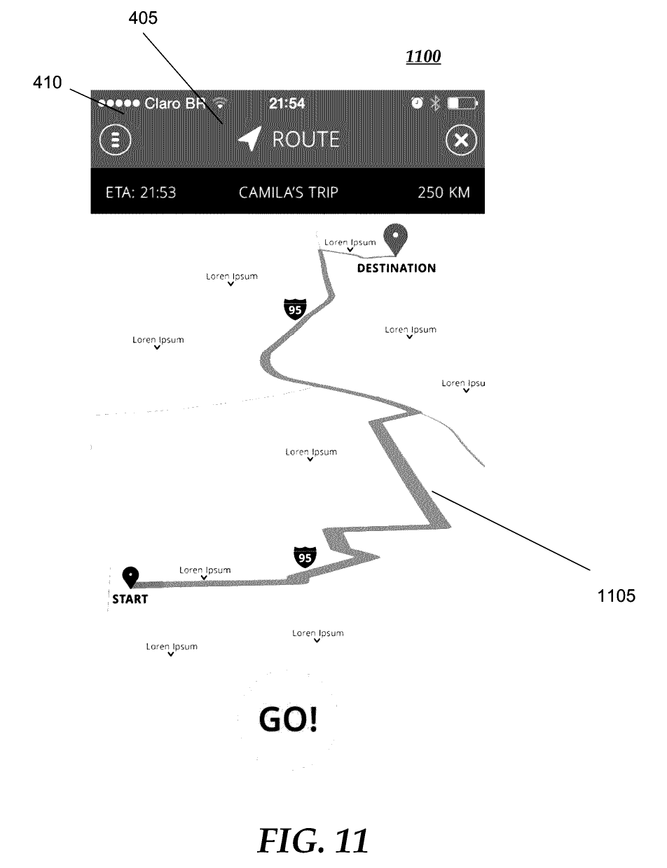

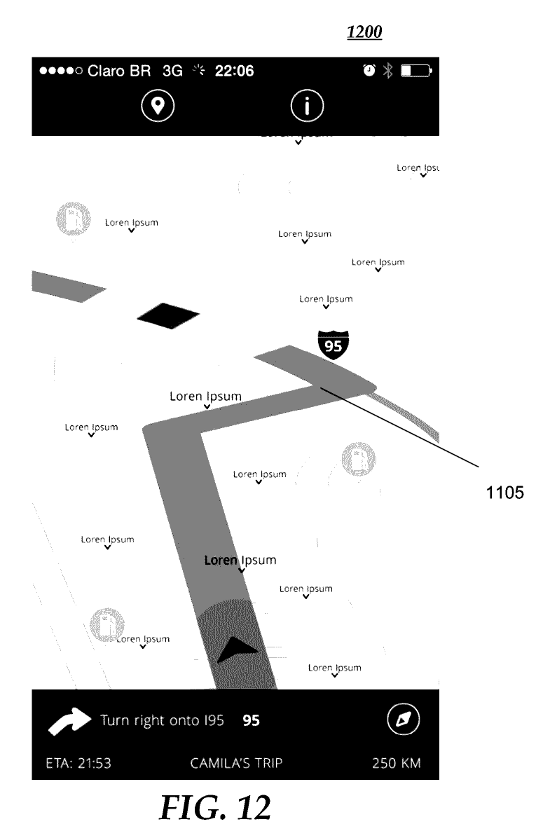

After platform 100 receives travel information and adds the travel information to the collaborative calendar in stage 240, method 200 may proceed to stage 250 where computing device 2600 may provide navigation guidance or other services related to the user's trip. For example, platform 100 may utilize GPS and other location tracking methods for offering real-time navigation instructions or redirect to a third-party platform to buy tickets/book a stay, and the like. As another example, in addition to providing navigation instructions, benefits related to the final plan such as for example, a link to a third-party hotel booking App may be provided. However, in some embodiments, the step 250 may be optional. FIG. 11 illustrates a screenshot of an embodiment of the present disclosure showing a route selection for a user. FIG. 12 illustrates a screenshot of an embodiment of the present disclosure displaying real-time navigation. Once computing device 2600 provides navigation guidance or other services in stage 250, method 200 may then end at stage 260.

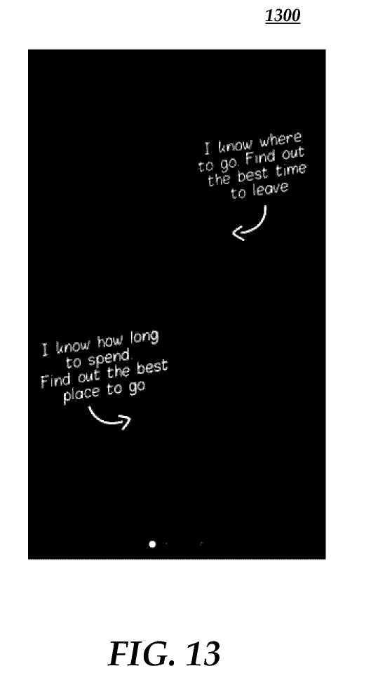

FIG. 13 to FIG. 16 illustrate a plurality of wireframes that, in some embodiments, may be provided to platform users. The illustrations only depict a non-limiting user interface that may be provided in some embodiments. There are used herein to illustrate a user-flow.

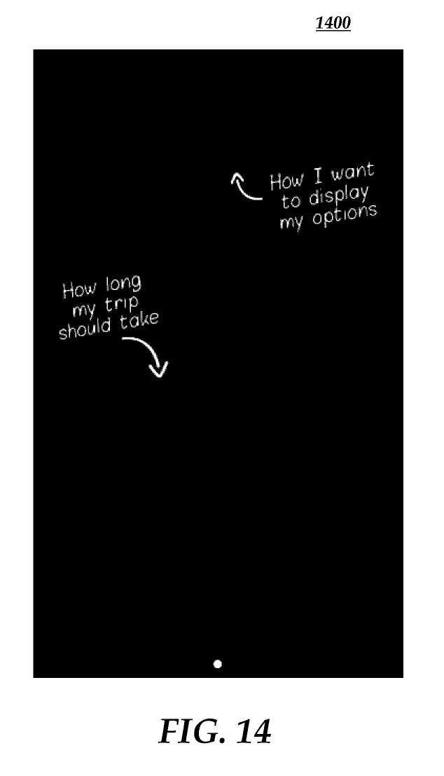

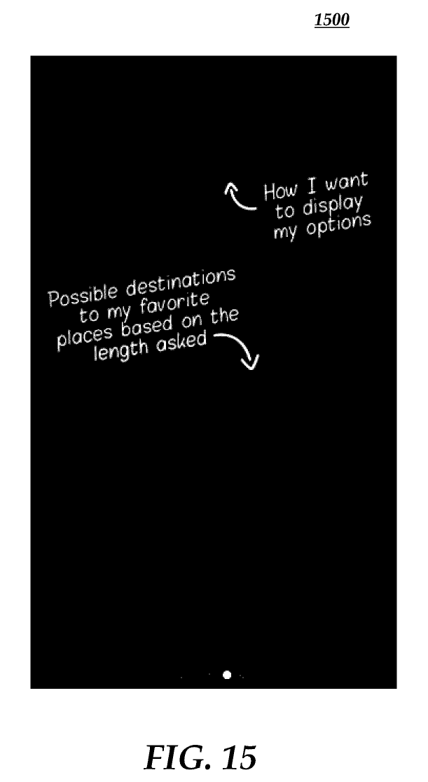

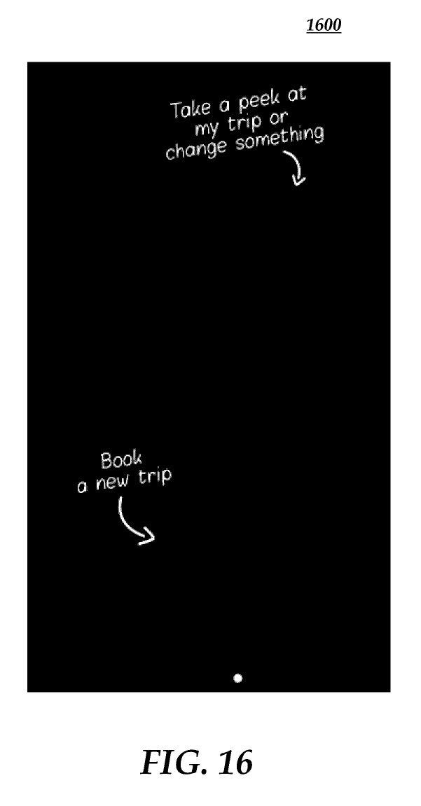

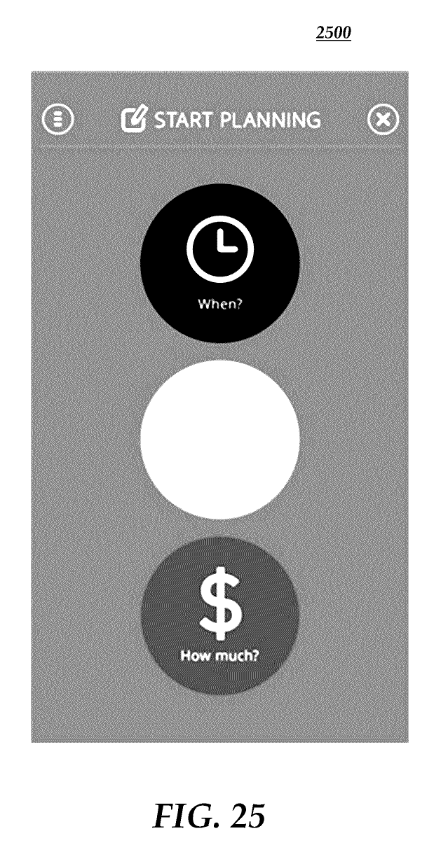

For example, a user may be provided with a first interface, as exemplarily illustrated in FIG. 13, with a selection of options. A first option may enable a user to enter a second interface, in which the user would specify a desired destination. A second option may enable the user to enter into a third interface in which the user may specify a trip time/day and duration. Accordingly, the user may be presented with a list of travel times corresponding to different times of the day entered by the user, as illustrated in FIG. 14. Alternatively, the user may also be presented with a list of destination locations that may be reached within a travel time specified by the user, as illustrated in FIG. 15. Further, a third option may enable the user to enter a third interface in which the user would be provided with, for example, a listing (or, for example, a calendar) associated with the various trips the user has planned through the platform, as exemplarily illustrated in FIG. 16. This may enable the user to change any details on the calendar such as, but not limited to, for example, the time and day of departure evaluating conditions at the time of consultation. It should be understood that a plurality of other options may be provided to the user, and such options may be correlated with a functionality of the platform. For example, the platform may be further configured to enable a user to specify a budget and be provided a selection of destinations and associated travel times within the budget, as illustrated exemplarily in FIG. 25.

Referring now to the second interface in which the user may specify a desired destination. The user may specify a “from” location (e.g., the user's current location, which may be obtained from the user's device) and a destination location (e.g., the users desired location). The user may further specify a desire time/day of departure and, in some embodiments, desired arrival time/day. In turn, the platform may perform the aforementioned calculations of method 200 and return the user with a plurality of results, as exemplarily illustrated in FIG. 15.

The results may include the price and, for example, durations of total travel time (including, for example, but not limited to the sum of, travel time to the airport, airport security control time, arrival time, flight time, and travel time from the airport to the destination). The results may further include alternate departure times on around same day specified by the user. The alternate departure times may be based on a reduced travel time and/or a reduced cost of the alternate departure time.

Turning now to yet another interface in which the user may specify a desired travel time and day for a trip. The user may be provided with an interface in which the user may filter through a plurality of alternate options for a trip. For instance, the user may specify a desired destination and be provided with a plurality of departure times for the same day. In other embodiments, as displayed in the subsequent interface, the user may specify a duration for the trip and a date, while the platform may calculate a plurality of destinations and times at which the user may embark on those trips to fulfil the desired travel time. Consistent with embodiments of the present disclosure, the user may specify a specific time but request a plurality of alternate dates for a desired destination or trip duration.

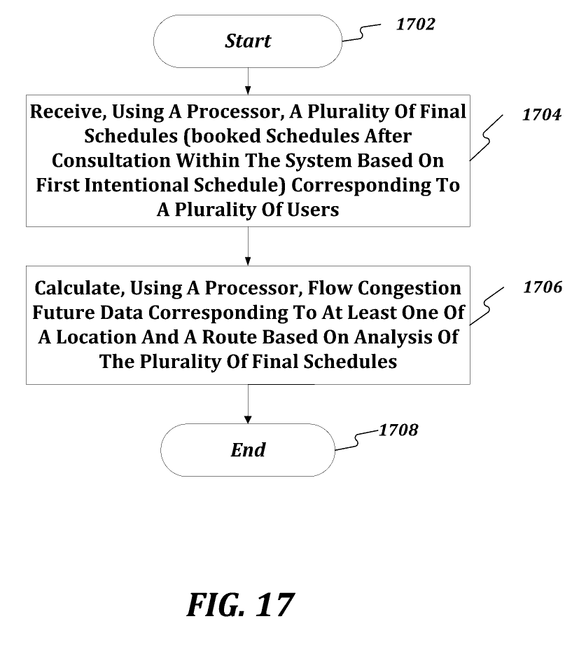

Turning now to FIG. 17, a flow chart of a method of receiving a user's final travel plan to process a forecasted flow congestion data in accordance with various embodiments is illustrated. The method may begin at step 1702 and proceed to step 1704 of receiving, using a processor, a plurality of final/saved schedules corresponding to a plurality of users. In some embodiments, the plurality of schedules may be included in a collaborative calendar accessible to each of the plurality of users. For example, the platform 100 may host a collaborative calendar that may be accessed by the plurality of users through a web interface/mobile App. In some other embodiments, a schedule corresponding to a user may be included in the user's calendar. For instance, the schedule may be included in a calendar application executable on the user's mobile device. Further, the calendar application may be configured to be in communication with platform 100. Accordingly, the schedule included in the user's calendar may be accessible to the platform 100.

Further, the method may include a step 1706 of calculating, using a processor, flow congestion data corresponding to one or more of a location and a route based on analysis of the plurality of final/saved schedules. Furthermore, in some embodiments, the method may further include receiving, using a processor, one or more routes connecting the location of the user to the destination.

In general, the schedule may include any information that may be indicative of flow congestion of one or more of people and vehicles. In some embodiments, the schedule may include appointments corresponding to events such as meetings, concerts, conferences, trip, a sale, outing, ski resort etc. Further, in some embodiments, the schedule may include one or more of a location and a time./day For instance, the schedule may include a place and time of a concert. Additionally, the location included in the schedule may be reachable through at least part of the route. For instance, different users from different starting points may travel through at least a part of the route in order to arrive at the location.

Further, in some embodiments, the time included in the schedule may correspond to one or more of a departure time and an arrival time. The departure time may be a time at which a corresponding user is scheduled to depart from the location. Further, the arrival time may be a time at which a corresponding user may be scheduled to arrive at the location.

In some embodiments, the congestion data may include a number of people scheduled to visit the location. Further, in some other embodiments, the flow congestion data may include a number of vehicles scheduled to travel through at least part of the route. Furthermore, in some embodiments, the flow congestion data may include a number of people scheduled to travel through at least part of the route.

In some embodiments, the method 1700 may further include a step of calculating, using a processor, a travel time corresponding to one or more of the location and the route based on the flow congestion data. Further, in some embodiments, the travel time may be calculated for each of a plurality of departure times. Accordingly, the travel time may be calculated based on flow congestion data corresponding further to one or more of a day of the week and a time of the day. As a result, travel times corresponding to different times of the day and different days of the week may be determined, and further dates may be presented (such as during a certain month or season, etc.).

In some embodiments, the method 1700 may further include a step of receiving, using a processor, each of a current location of a user, a destination location and a departure time. The current location of the user may be received, for example, from a GPS enabled mobile device operated by the user. The destination location and the departure time may be, entered by the user through a user interface presented to the user.

Further, the method 1700 may include a step of displaying, using a processor, flow congestion data corresponding to a plurality of times/days. Additionally, the flow congestion data may correspond to one or more routes connecting a location of the user to the destination. In some embodiments, the location of the user may include a current location of the user. In some other embodiments, the location may be entered by the user through a user interface provided to the user by the platform 100. In some other embodiments, the location of the user may be determined based on location information transmitted to the platform 100 by a GPS enabled mobile device operated by the user.

Furthermore, the flow congestion data may further correspond to the departure time. In some embodiments, the departure time may include a date and a time of day. Additionally, the plurality of times may include the departure time. Accordingly, flow congestion data corresponding to different times of a day and different days of a week or month for different routes may be calculated and displayed.

In some embodiments, the method 1700 may further include estimating a time duration corresponding to each of the one or more routes connecting the location to the destination. Further, the method 1700 may include a step of displaying, using the processor, the time duration corresponding to each of the one or more routes. As a result, a user may be informed about how long it may take to reach the destination through different routes as the User selects them.

In some embodiments, the method 1700 may further include a step of identifying, using a processor, one or more of an alternative route, an alternative destination and an alternative departure time. In general, an alternative route, an alternative destination or alternative departure time may be optimum compared to a corresponding route, destination and departure time/day specified by a user. In other words, for a constraint provided by the user, such as a given travel time or a budget, the route, destination and the departure time specified by the user may not be optimum as compared to the alternative route, alternative destination and the alternative departure time respectively.

In some embodiments, the flow congestion data corresponding to one or more of alternative route, the alternative destination and the alternative departure time/day may be lower than flow congestion data corresponding to the route, the destination and the departure time respectively. However, in some embodiments, one or more of a travel time and a cost associated with one or more of the alternative route, the alternative destination and the alternative departure time may be similar to one or more of a travel time and cost associated with the route, the destination, and the departure time respectively.

Further, the method 1700 include a step of displaying, using a processor, one or more of the alternative route, the alternative destination and the alternative departure time/day.

Additionally, in some embodiments, the method 1700 may further include a step of receiving, using a processor, one or more of time duration and a budget. Further, the method may include a step of identifying, using a processor, one or more of one or more routes connecting the current location the destination location and one or more departure times based on each of the flow congestion data and one or more of the time duration and the budget. Further, a travel time corresponding to each of the one or more routes and the departure time may be less than or equal to the time duration. Furthermore, a cost of travelling corresponding to each of the one or more routes and a departure time may be less than or equal to the budget. Additionally, the method may include a step of displaying, using a processor, one or more of flow congestion data and cost corresponding to one or more of the one or more routes and the one or more departure times. As a result, a user may be facilitated to plan their travel in a more cost effective and time effective manner.

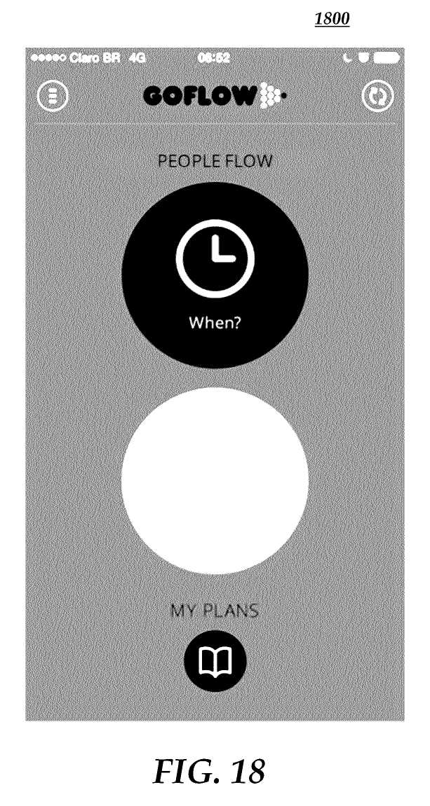

Turning now to FIG. 18 to FIG. 25, a plurality of wireframes that, in some embodiments, may be provided to platform users is illustrated. The illustrations only depict a non-limiting user interface that may be provided in some embodiments. There are used herein to illustrate a user-flow.

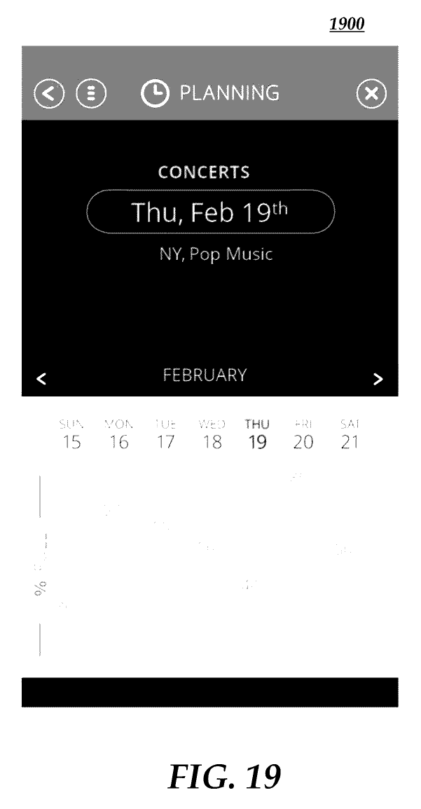

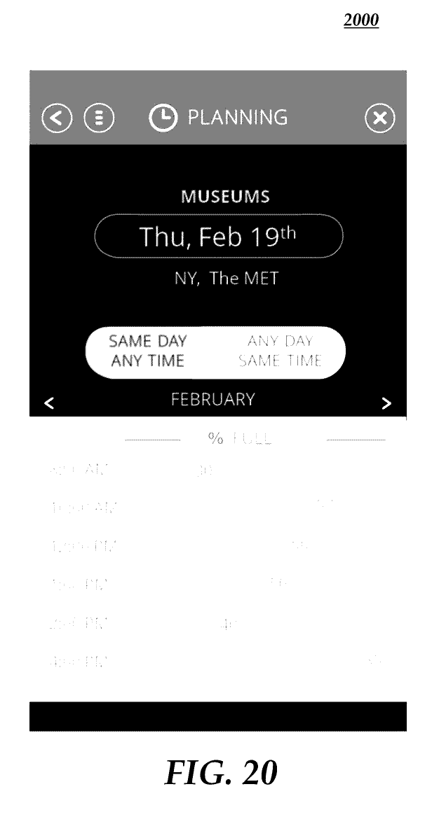

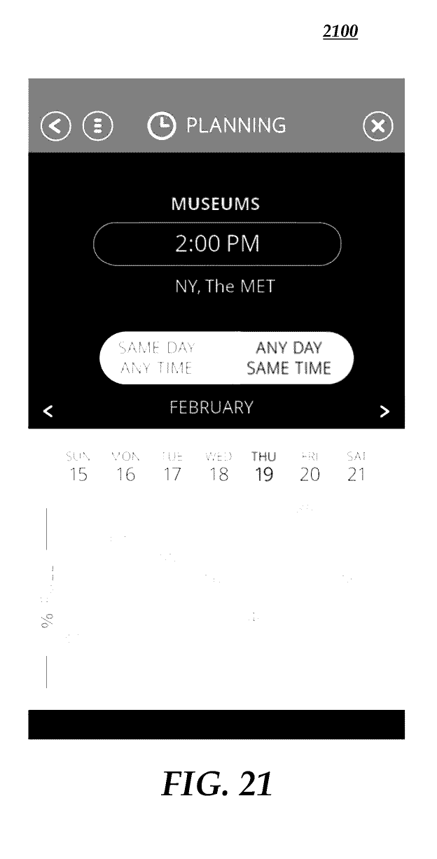

For example, an interface such as depicted in FIG. 18 may be presented to a user to facilitate planning attendance of an event such as, for example, a concert. The interface may enable the user to enter a time/day of the event and a location of the event. Subsequently, execution of the methods 200 or 1700 as disclosed earlier may result in a screen as exemplarily depicted in FIG. 19. As shown, the based on the analysis of calendar information of other users, the methods disclosed herein may forecast congestion flow data, such as number of people scheduled to visit the event. For instance, the number of people may be indicated in terms of an occupancy level expressed as a percentage value as depicted in FIG. 19. As shown, for the event “Concert” at “NY, Pop Music”, the congestion flow data displayed in accordance with various embodiments indicates that congestion is least on Thursday. Similarly, congestion flow data for the event at different times of a day may also be displayed as exemplarily shown in FIG. 20. As shown, congestion for the event “Museum” at “NY, The MET” on the selected date, the congestion flow data displayed in accordance with various embodiments indicates that congestion is least during 2 pm-3 pm. Likewise, the congestion flow data may also be calculated for different days of the week/month for a given time duration and displayed to the user, as exemplarily shown in FIG. 21. As a result, a user may be informed about congestion of people at a place or an event at different times of the day and different days of the week/month. Accordingly, the user may plan a visit to the place or the event in a convenient manner, having made a well-informed decision about attending an event.

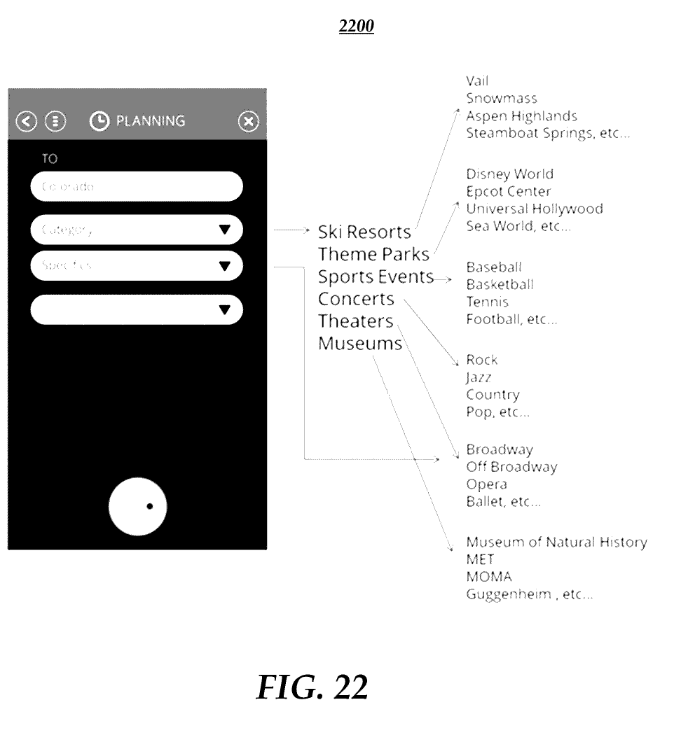

As another example, the user may be presented with an interface as illustrated in FIG. 22 in order to facilitate planning of trips. As shown, several options may be presented to the user to select trip parameters such as a destination location, a category of activity/event, a sub-category of specifics and date. For example, the user may select the destination location as Colorado and the category of activity/event as “Ski Resort”, and “Snowmass” as the sub-category and the date as Feb. 19^{th}.

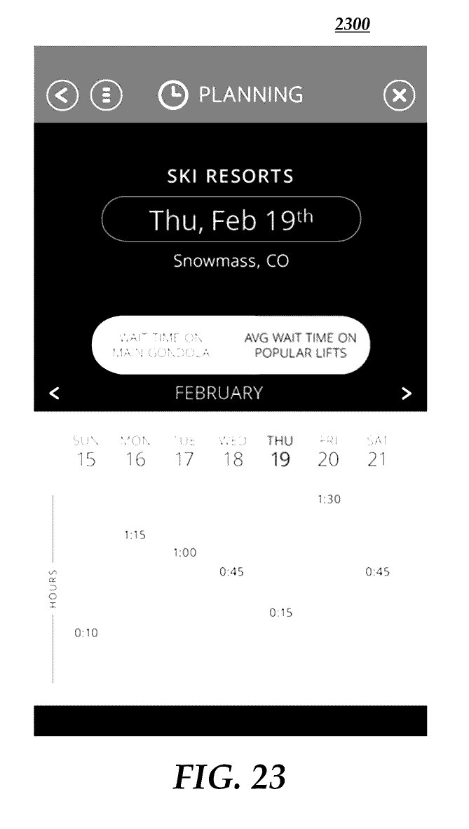

Accordingly, the user may be presented with an interface as illustrated in FIG. 23 that may display congestion flow data such as, wait times on main gondola and average waiting times on popular lifts, corresponding to different times of the day. Further, the user also may be presented with an option to view congestion flow data, such as wait times.

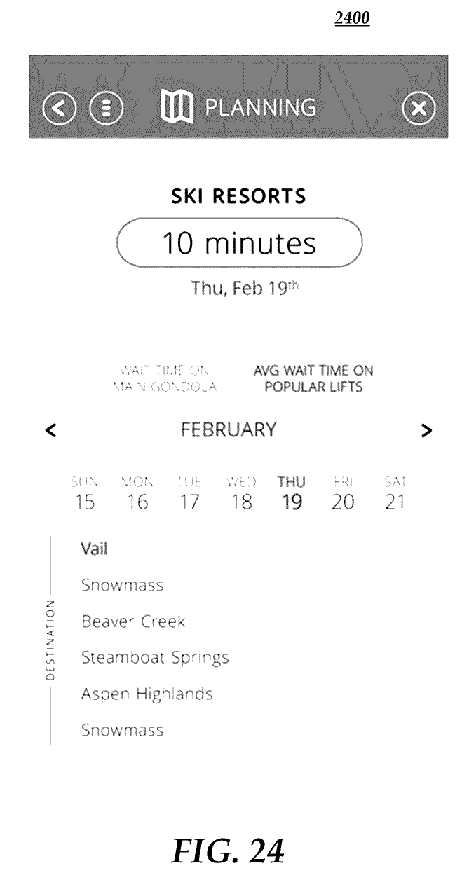

FIG. 24 illustrates a user that desires to fix a certain amount of wait time and the platform will bring options of destinations based on the criteria selected (such as “Ski Resorts” in “Colorado”). FIG. 24 is an analogy to FIG. 5 and FIG. 6, where the user is also given options of places for a certain pre-given duration of trip. The difference here is just the type of flow, FIG. 24 relates to people flow. Still consistent with embodiments of the present disclosure, a user may specify a threshold wait time and the platform may provide selections for various events and/or destinations that match the threshold wait time.

IV. Platform Architecture

The flow congestion predictor with calendar feedback platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform 100 may be hosted on a centralized server, such as, for example, a cloud computing service such as a server and the like. Although method 200 has been described to be performed by a computing device 2600, it should be understood that, in some embodiments, different operations may be performed by different networked elements in operative communication with computing device 2600.

Embodiments of the present disclosure may comprise a system having a memory storage and a processing unit. The processing unit coupled to the memory storage, wherein the processing unit is configured to perform the stages of method 200. It should be understood that the memory storage may comprise instructions for executing a continually updating algorithm as referenced above.

FIG. 26 is a block diagram of a system including computing device 2600. Consistent with an embodiment of the disclosure, the aforementioned memory storage and processing unit may be implemented in a computing device, such as computing device 2600 of FIG. 26. Any suitable combination of hardware, software, or firmware may be used to implement the memory storage and processing unit. For example, the memory storage and processing unit may be implemented with computing device 2600 or any of other computing devices or cloud services 2618, in combination with computing device 2600. The aforementioned system, device, and processors are examples and other systems, devices, algorithms, and processors may comprise the aforementioned memory storage and processing unit, consistent with embodiments of the disclosure.

With reference to FIG. 26, a system consistent with an embodiment of the disclosure may include a computing device or cloud service, such as computing device 2600. In a basic configuration, computing device 2600 may include at least one processing unit 2602 and a system memory 2604. Depending on the configuration and type of computing device, system memory 2604 may comprise, but is not limited to, volatile (e.g. random access memory (RAM)), non-volatile (e.g. read-only memory (ROM)), flash memory, or any combination. System memory 2604 may include operating system 2605, one or more programming modules 2606, and may include a program data 2607. Operating system 2605, for example, may be suitable for controlling computing device 2600′s operation. In one embodiment, programming modules 2606 may include flow congestion data analysis (a developed algorithm), route optimization and navigation modules. Furthermore, embodiments of the disclosure may be practiced in conjunction with a graphics library, other operating systems, or any other application program and is not limited to any particular application or system. This basic configuration is illustrated in FIG. 26 by those components within a dashed line 2608.

Computing device 2600 may have additional features or functionality. For example, computing device 2600 may also include additional data storage devices (removable and/or non-removable) such as, for example, magnetic disks, optical disks, or tape. Such additional storage is illustrated in FIG. 26 by a removable storage 2609 and a non-removable storage 2610. Computer storage media may include volatile and nonvolatile, removable and non-removable media implemented in any method or technology for storage of information, such as computer readable instructions, data structures, program modules, or other data. System memory 2604, removable storage 2609, and non-removable storage 2610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), cloud services or other optical storage, magnetic cassettes, magnetic tape, magnetic disk storage or other magnetic storage devices, or any other medium which can be used to store information and which can be accessed by computing device 2600. Any such computer storage media may be part of device 2600. Computing device 2600 may also have input device(s) 2612 such as a keyboard, a mouse, a pen, a sound input device, a touch input device, etc. Output device(s) 2614 such as a display, speakers, a printer, etc. may also be included. The aforementioned devices are examples and others may be used.

Computing device 2600 may also contain a communication connection 2616 that may allow device 2600 to communicate with other computing devices 2618, such as over a network in a distributed computing environment, for example, an intranet or the Internet. Communication connection 2616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2604, including operating system 2605 and cloud services. While executing on processing unit 2602, programming modules 2606 (e.g., application 2620) may perform processes including, for example, one or more of method 200's stages as described above. The aforementioned process is an example, and processing unit 2602 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method/algorithm), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process (algorithm). Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, propagation medium or cloud service. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM or through cloud services. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method of planning and distributing flows based on flow congestion data, the method comprising:
receiving an intentional travel plan;
calculating, using a processor, multiple travel options based on flow congestion data; and
presenting the multiple travel options to users based on the intentional travel plan.

2. The method of claim 1, wherein receiving the intentional travel plan comprises receiving at least one of the following: a departure time, a departure date, a duration of travel, and a destination.

3. The method of claim 2, wherein the destination comprises at least one of the following: an event, a venue, and a physical location.

4. The method of claim 2, wherein presenting the multiple travel options to the users based on the intentional travel plan comprises presenting an alternative destination.

5. The method of claim 4, wherein presenting the alternative destination comprises presenting the alternative destination location that is similar to the destination specified in the intentional travel plan.

6. The method of claim 4, further comprising determining the alternative destination is determined based on flow congestion data.

7. The method of claim 6, wherein determining the alterative destination comprises determining the alternative destination based on a duration of travel in conjunction with the flow congestion data.

8. The method of claim 8, further comprising displaying the flow congestion data corresponding to the alternative destination, wherein flow congestion data corresponds to at least one route to the alternative destination.

9. The method of claim 2, wherein presenting the multiple travel options comprises presenting at least one of the following: an alternative departure time and an alternative departure date.

10. The method of claim 8, further comprising determining at least one of the following: the alternative departure time and the alternative departure date based on the flow congestion data.

11. The method of claim 8, further comprising displaying the flow congestion data corresponding to the alternative departure time, wherein flow congestion data corresponds to at least one route to the destination.

12. The method of claim 1 further comprising:
receiving a plurality of schedules corresponding to at least one of the following: a plurality of individuals and a plurality of organizations; and
wherein the flow congestion data is calculated based at least in part on an analysis of each of the plurality of schedules.

13. The method of claim 10, wherein receiving a plurality of schedules comprises receiving calendar data associated with at least one of the following: the plurality of individuals and the plurality of the organizations.

14. The method of claim 1, wherein the flow congestion data comprises at least one of the following: a number of people scheduled to visit a destination associated with the intentional travel plan, a level of occupancy at the destination, an absolute occupancy limit at the destination, and wait times at the destination.

15. The method of claim 3, wherein the flow congestion data comprises a number of vehicles scheduled to travel through at least part of route to the destination.

16. The method of claim 3, wherein the flow congestion data further comprises a number of people scheduled to at least one of the following:
travel through at least part of a route to the destination, and be located at the destination.

17. The method of claim 2, further comprising:
identifying, using a processor, alternative travel data, the alternative travel data comprising at least one of the following: an alternative route, an alternative destination, an alternative departure time, and an alternative departure day,
wherein flow congestion data corresponding to alternative route, the alternative destination, the alternative departure time, and the alternative day is similar to or lower than the flow congestion data corresponding to the intentional travel plan, and
wherein presenting the travel option comprises displaying at least one of the alternative route, the alternative destination, the alternative departure day, and the alternative departure time.

18. The method of claim 17, wherein at least one of the following: a travel time and a cost associated with at alternative travel data is similar to or less than at least one of a travel time and cost associated with the intentional travel plan.

19. The method of claim 12 further comprising:
receiving at least one of a time duration and a budget; and
identifying, using a processor, at least one of at least route connecting the current location the destination location and at least one departure time based on each of the flow congestion data and at least one of the time duration and the budget, wherein a travel time corresponding to each of the at least one route and departure time is similar to, less than or equal to the time duration, wherein a cost of traveling corresponding to each of the at least one route and a departure time is less than or equal to or even similar to the budget; and
displaying, using a processor, at least one of flow congestion data and cost corresponding to at least one of the at least one route and the at least one departure time.

20. A method of facilitating planning travel based on flow congestion data, the method comprising:
receiving, using a processor, an intentional travel plan comprising each of a destination, a departure time and day and a duration of travel, or the intentional attendance to venue;
receiving, using a processor, a plurality of final schedules corresponding to a plurality of users, wherein a final schedule of a user comprises each of a starting point of the user, the destination and a scheduled time of arrival of the user at the destination, or the final attendance to a venue;
calculating, using a processor, flow congestion data corresponding to each of a plurality of departure times and a plurality of departure days, or the plurality attendance to a venue related to different times, wherein the flow congestion data further corresponds to at least one of the destination and a route connecting the starting point to the destination, wherein the flow congestion data is calculated based on an analysis of the plurality of final schedules, or the flow congestion data further corresponds to at least one of the level of occupancy and wait times;
displaying, using a processor, each of the plurality of departure times and the corresponding flow congestion data, wherein the flow congestion data corresponding to a departure time comprises a travel duration for departing at the departure time and arriving at the destination through a route connecting the starting point to the destination;
calculating, using a processor, multiple travel options based on flow congestion data;
displaying, using a processor, the multiple travel options to users based on the intentional travel plan;
calculating, using a processor, multiple options of venues and times to attend based on flow congestion data; and
displaying, using a processor, the multiple options of venues to users based on the intentional plan or category.
